(19) United States
(12) Patent Application Publication
(10) Pub. No.: US 2010/0118652 A1
(43) Pub. Date: May 13, 2010

(54) Determination of depth moveout and of residual radii of curvature in the common angle domain

(75) Inventor: Jorg Friedrich Schneider, Nordstemmen (DE)

Correspondence Address: Schneider, Jorg, Bureau of applied geophysics, 17, Dorfstr., Nordstemmen, 31171, DE

(73) Assignee: Jorg Friedrich Schneider, Nordstemmen (DE)

(21) Appl. No.: 12/269,994

(22) Filed: Nov. 13, 2008

(51) Int. Cl. G01V 1/28

(52) U.S. Cl. 367/52

(57) ABSTRACT

A method is disclosed for processing seismic data. The method includes prestack depth migrating seismic measurements to compute common angle domain image gathers with an initial depth model. Residual moveout analysis is performed in the common angle domain, moveout corrections are derived in terms of the residual radii of curvature at zero reflection angle. Corrections for larger reflection angles are obtained from separate analyses for the coefficients of suitable series expansions. The residual radii of curvature at zero reflection angle can be used to improve the signal to noise ratio of the migrated data and to assess or improve the velocity model used for the prestack depth migration.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

The invention relates to geophysical processing using seismic measurements, and in particular to methods for correcting migrated seismic measurements and for estimating the propagation velocities of seismic waves.

2. Background Art

Seismic surveying is a method of exploration geophysics that uses the principles of seismology to determine geologic structures of interest, primarily for oil and gas prospection. Usually seismic data is recorded at the surface of the earth, methods of seismic processing are used to transform the measured seismic data into an image of the subsurface. Surveying includes a number of seismic measurements where each measurement consists of an array of receivers and of one or more energy sources. The energy sources are triggered and the released energy penetrates through the geological formations of the subsurface; the propagating waves are reflected or scattered at formation boundaries or at reflecting or scattering objects and are finally recorded as a function of time at the receiver array. For two-dimensional (2D) measurements shots and receiver are approximately placed along the same line, whereas for three-dimensional (3D) measurements even one shot receiver configuration may have an areal extent. In both cases the shot positions are usually used once, but the same receiver positions are used for several shots. For 2D measurements this procedure is referred to as continuous profiling.

This redundancy of the measurements was devised to increase the ratio of the power of the primary reflected signal versus the ambient background noise, commonly referred to as the signal to noise ratio as described in Mayne, W., “Common reflection point horizontal data stacking techniques”, Geophysics, 27, 927-938 (1962, see also U.S. Pat. No. 2,732,906): the recorded seismic traces are grouped into common midpoint (CMP) gathers with common shot-receiver midpoint and different shot-receiver distances (offsets). A moveout analysis as described in Neidell, N. and Taner, T., “Semblance and other coherency measures for multichannel data”, Geophysics, 36, 482-497, (1971) is performed with the help of programmable computers for individual gathers or for groups of gathers. For suitable time windows within the gathers time samples are summed along hyperbolic trajectories with respect to time and offset. For a fixed time at zero offset the summation curves are defined by a parameter which is commonly called the stacking velocity. In the moveout analysis stacking velocities are determined at particular CMP positions for particular zero offset times, usually for time windows centering at reflected seismic events. Often that value for the stacking velocity is picked which maximizes the semblance coefficient; this coefficient is a measure of the normalized coherence in a particular time window as described in the cited reference by Neidell and Taner and varies between zero (no coherence) and one (optimal coherence). After an appropriate interpolation a stacking velocity will be available for each zero offset time at each CMP position. Finally, the measured seismic traces within a CMP gather are corrected along the hyperbolic trajectories determined in the analysis and are summed to form one stacked trace. It is well known that the signal to noise (S/N) ratio of the stacked trace increases by the square root of the number of the traces in the CMP gather, if the corrected events align with identical waveforms at the same travel times.

The actual form of the hyperbolic correction and its inversion was originally derived for a sequence of horizontal reflectors with constant propagation velocities in Dix, H. “Seismic velocities from surface measurements”, Geophysics, 20, 68-86, (1955). In subsequent publications described in Hubral, P. and Krey, Th., “Interval velocities from seismic reflection measurements”, Society of Exploration Geophysicists (1980), the approach was extended to the more realistic case of a subsurface where velocities vary both in the vertical and the lateral directions: an approximation to the stacking velocity can be obtained at the earth's surface from the principal radii of a wavefront which starts as a point source and propagates upwards along a ray perpendicular to the considered reflector. The application is strictly valid only at zero offset, however, a one term correction formula in terms of the stacking velocity can be applied with sufficient accuracy for many measured profiles up to midrange offsets of about 2500 m. A common approach for the correction of traces with larger offsets is to approximate the original hyperbolic correction suitably, for example in terms of a power series or a rational approximation and to determine the coefficients independently of each other. For each coefficient in the expansion a separate velocity analysis has to be performed as described in Taner, T., Treitel, S., and Al-Chalabi, M. “A new travel time estimation method for horizontal data”, SEG, Expanded Abstracts, 2273-2276, (2005), for the case of a rational two term expansion.

The transformation of the measured data into a depth image of the subsurface is achieved with programmable computers by the process of seismic depth migration; if stacked traces are migrated the resulting traces are referred to as poststack depth migration, the migration of the unstacked traces is called prestack seismic depth migration (PSDM). In the process of PSDM the redundancy of the input data is maintained: at a particular lateral location the migrated depth traces may be computed as common incidence (CIG), angle domain common incidence (ADCIG) gathers or as angle domain common image gathers (ACIG). Traces are sorted according to the original offset within a CIG, and according to the scattering angle at the migrated position within an ADCIG as described in Xu, S., Chauris, H., Lambaré, G., and Noble, M. “Common-angle migration: A strategy for imaging complex media” Geophysics, 66, 1877-1894, (2001); for ACIGs a plane wave decomposition is is performed as described in Akbar, F., Sen, M., Stoffa, P., “Prestack plane-wave Kirchhoff migration in laterally varying media”, Geophysics, 61, 1068-1079 (1996). For the migration of the data a velocity model is required; one of the most difficult tasks in exploration seismology is to obtain representative velocities for the geological formations which render an accurate image of the subsurface. After PSDM with an accurate velocity model the migrated events within the migrated trace gathers align themselves at the correct depth positions, whereas residual moveout will be observed after the migration with inaccurate velocities.

Some of the developments in the residual moveout analysis after PSDM began more than twenty years ago when Al-Yahya, K., “Velocity analysis by iterative profile migration”, Geophysics, 54, 718-729 (1989), derived a hyperbolic moveout correction for a medium with constant propagation velocity and for a horizontal reflector. The results of the moveout analysis could be used for correction purposes to improve the S/N ratio (analogous to the correction of the measured time traces), but it was also possible to invert the correction, i.e. to determine a velocity for a new PSDM. The subsurface was divided into horizontal layers each with constant propagation velocity and the processing proceeded by treating the individual layers consecutively with increasing depth, commonly called layer stripping. However, the assumptions of horizontal layering and of constant velocities are not realistic for typical geological formations encountered in hydrocarbon exploration. In subsequent years methods have been developed to determine and invert corrections for slightly dipping reflectors and for velocity distributions with small lateral variations e.g. in Biondi, B. and Symes, W., “Angle-domain common image gathers for migration analysis by wavefield-continuation imaging”, Geophysics, 69, 1283-1298 (2004), or in Meng, Z., Bleistein, N. and Wyatt, K., “3-D Analytical migration velocity analysis 1: Two-step velocity estimation by reflector-normal update: SEG, Expanded Abstracts, 1727-1730 (1999), usually by updating the velocity along the normal of the reflector considered.

A different approach originated at about the same time, described by Yilmaz, O and Chambers, R., “Migration velocity analysis by wavefield extrapolation”, Geophysics, 49, 1664-1674 (1984), but also in several publications cited in Goldin, S., “Determination of velocity from parameters of focusing of reflected waves”, Geologiya i Geofizika, 24, 88-94 (1983): PSDM can also be considered as downward continuation of the measuring surface into the subsurface, where the migration result for the computed time section at a particular depth level is defined by the samples at zero time. The residual moveout observed after PSDM with an inaccurate velocity model vanishes as the migrated events are propagated upwards or downwards. At a different depth and at nonzero travel times an almost horizontal alignment of the events can be observed. This phenomenon is referred to as focusing and was used in the cited publications to estimate the true propagation velocity. In later publications cited in Wang, B., Qin, F., Dirks, V., Guillaume, P., Audebert, F., Epili, D., “3D finite angle tomography based on focusing analysis”, SEG-meeting, Expanded Abstracts, 2546-2549 (2005), rays were considered with wavefronts starting as point sources at the true reflector position in the true velocity model which were propagated to the earth's surface and downward continued into the velocity model used for PSDM. It was shown that for a constant propagating velocity the times and positions of the focused events can be related to the residual curvature of these rays terminating perpendicular to the considered reflector at the migrated positions. The true propagation velocities can be determined from the residual radii of curvature in a separate step. However, it has to be remarked that the determination of the residual radii in a focusing analysis is much more elaborate than the determination of the stacking velocities in a moveout analysis, because the data volume which is to be computed and analyzed is significantly larger. For this reason an initial PSDM was usually performed only for groups of CIGs; a correction of migrated gathers for a continuous analysis of the reflecting horizons of interest was not possible.

In Liu, W., Popovici, A., Bevc, D. and Biondi, B. “3D migration velocity analysis for common image gathers in the reflection angle domain”, SEG-meeting, Expanded Abstracts, 885-888, (2001, see also U.S. Pat. No. 6,546,339) a solution was presented for velocity analyses and velocity inversion for ACIGs. Apart from a vertical update of the velocity field with the computed correction and a full inversion an update along zero offset rays was suggested. Some differences of the latter approach to the invention are explained in the detailed description which follows; another major difference is that ACIGs are obtained after a incident plane wave decomposition as described in the cited reference by Akbar et al., whereas ADCIGs are decomposed into contributions of equal scattering angle with respect to the normal of a dipping reflector at the migrated position as described in the cited reference by Xu et al. A solution for velocity analyses after PSDM for CIGs was presented by Jiao, J. and Martinez, R., “Horizon-based residual depth and time migration velocity analysis”, SEG-meeting, 2108-2111, (2003, see also U.S. Pat. No. 7,065,004), for the layer stripping approach. There is a vertical update of the velocity model, the correction terms in both solutions discussed in this paragraph are obtained from considerations for a horizontally stratified medium.

In a recent publication in Schneider, J., “Residual moveout analysis and velocity determination for parametric media”, SEG-meeting, 2817-2821, (2007), a residual depth moveout correction (RDMO) was proposed for CIGs. Residual radii of curvature at zero offset can be obtained after preliminary raytracing computations. Differences to the invention will become apparent in the detailed description which follows.

The parameters determined in the moveout analysis can be used for different purposes: it has been stated above that the S/N ratio of the stacked traces after PSDM will be improved. In addition, the residual radii of curvature can be used to assess the quality of the velocity model used in the PSDM: the residual radii of curvature vanish everywhere only for the correct velocity model. If, on the other hand, large values are observed for the estimated residual radii, the velocity model should be corrected. For intermediate offsets and moderate differences between the used and the true velocity model it has been shown for the layer stripping approach that the residual radii of curvature can be inverted iteratively (references cited in the detailed description of the invention).

### SUMMARY OF THE INVENTION

The present invention provides a moveout analysis for seismic measurements after prestack depth migration comprising the steps of: establishing a set of seismic data and a velocity model corresponding to a volume of the subsurface; using a computer to perform a seismic migration of the measured data and to compute a set of angle domain common image gathers; using a computer to perform a moveout analysis and to determine approximations to the residual radii of curvature at zero offset.

One aspect of the invention is that the required parameters can be obtained directly from the depth migrated gathers; to establish a volume of the parameters as a function of depth or lateral position it is not necessary to invest more interpretive or computational effort than is required for performing a moveout analysis. The workload can be further reduced if the moveout analysis is integrated into a layer stripping approach for improving the velocity model and the formation velocities to be determined are restricted to laterally varying functions. In this case it suffices to analyze the moveout along the migrated position of the horizons considered.

Another aspect of the invention is the approximation of the residual radius of curvature at zero offset or zero angle of reflection. For smaller angles of reflection this parameter can be obtained directly from a small offset approximation computed along the expanding wavefront of a zero offset ray near the migrated position of the considered events. For larger reflection angles that moveout may be estimated by approximating the functional form of the zero offset correction by a suitable mathematical expansion which is dominated by the zero offset approximation for small reflection angles. The coefficients of the expansion are determined by successive moveout analyses and the residual radius of curvature at zero offset is estimated by suitable optimization schemes.

Other aspects and advantages of the invention will be apparent from the description and claims that follow.

### BRIEF DESCRIPTION OF THE DRAWINGS

FIGS. 1A and 1B show, respectively, the reflected event in the true velocity medium and construction of the moveout correction in an ADCIG in the velocity medium which was used for the PSDM.

FIGS. 2A and 2B show, respectively, a depth model with two formations for which model computations have been performed on a programmable computer and the laterally varying velocity distribution for the lower formation.

FIG. 2C shows a partial display (every 3^{rd} trace displayed) of the stacked traces after PSDM when instead of the correct lateral velocity of FIG. 2B a constant velocity of 2200 m/s was used.

FIGS. 2D, 2E and 2F show, respectively, the estimated optimal and the zero offset residual radii of curvature, one typical ADCIG at position x=6400 m after PSDM, and traces for the same ADCIG after RDMO with common angle less than 30 degrees.

FIGS. 2G and 2H show, the ADCIG of FIG. 2E for all common angles after PSDM and RDMO with a one term correction in FIG. 2G and after a rational two term correction in FIG. 2H.

FIG. 2I shows the semblance coefficient as a function of lateral position after the application of optimal one term and two term corrections to the traces in the ADCIGs.

FIG. 2J shows the residual radii of curvature computed from least mean square optimization and for zero offset.

### DETAILED DESCRIPTION

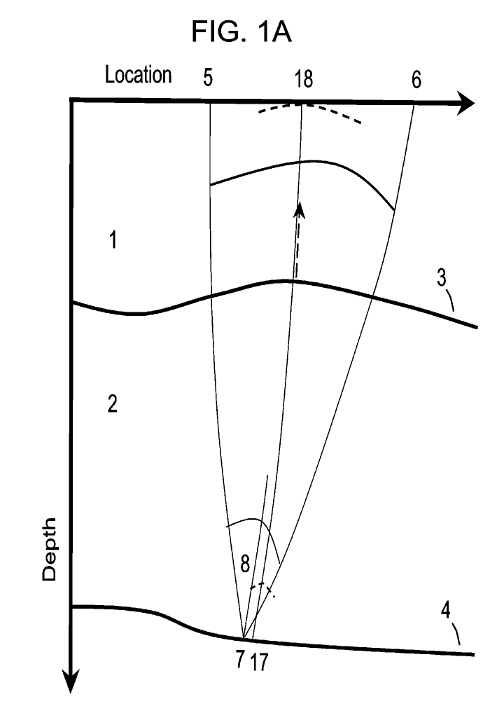

For purposes of understanding the invention the underlying physical principle of residual depth moveout correction is illustrated in FIGS. 1A and 1B. FIG. 1A shows a geological model of the subsurface consisting of two geological layers 1 and 2 which are defined by vertically and laterally varying propagation velocities and the reflection boundaries 3 and 4. For illustration purposes it is assumed in FIGS. 1A and 1B that the velocity model can be described by geological formations, with a separate velocity distribution for each formation. This approach is used in many geological situations, however, this restriction is not necessary: for the application of the invention a general velocity model as a function of depth and lateral position can be used.

A ray between the shot position 5, reflection boundary 4 and receiver position 6 is reflected at the reflection boundary at position 7 with reflection angle 8. Both legs of the reflected ray are backward propagated in time into the velocity model of FIG. 1B which was used for the PSDM of the measured data. In FIG. 1B the formation velocities 9 and 10 are different, the migrated reflection boundaries 11 and 12 are the position of the events in the migrated CIGs at zero offset. In it assumed that the residual moveout has to be determined for the migrated events for the reflection boundary 4 in FIG. 1A.

In FIG. 1B the backward propagated legs of the reflected ray intersect each other at position 15 where an event will be observed at a positive or negative time, corresponding to a positive or negative travel time differences between the reflected ray between positions 5, 7, 6 in FIG. 1A and the backward propagated ray between 5, 15, 6 in FIG. 1B. The event at this travel time can be upward propagated along the ray legs to intersect the migrated reflector 12 at positions 13 and 14. It is possible to find a position 17 on the reflector 4 in FIG. 1A which acts as a point source for a wavefront to be traced along a ray constructed perpendicular to the reflector 4. At the intersection with the earth's surface at position 18 the wavefront is backward propagated into the velocity medium in FIG. 1B and has a perpendicular intersection with the migrated reflector 12 at position 19 at the midpoint between positions 13 and 14. For small offsets and small differences between the two velocity models it is shown in Schneider, J., “Moveout analysis and velocity determination for angle-domain common image gathers”, EAGE-meeting, expanded abstracts, P162, (2008), and Schneider, J., “Residual moveout analysis and velocity determination for parametric media”, Geophysics, 73, VE361-VE367, (2008), that it is possible to express the residual moveout 22 of the considered event in terms of the residual radius of curvature of the wavefront at position 19. Using a constant velocity approximation in the vicinity of position 19 it is shown that the angle 16 between the constructed legs at the intersection 15 is about equal to the angle at 21 which is the angle of reflection between the shot at position 5, the receiver at position 6 and the migrated reflector 12 at position 20.

The resulting depth moveout Δz (22 in FIG. 1B) for an ADCIG can then approximated as

$$Δ z = \sqrt{{R}^{2} + {{R}^{2} ( \frac{ϕ}{2} )}^{2}} - R \qquad ( 1 )$$

with residual radius of curvature R at position 19 and common scattering angle φ (21, 16). In the case of a 3D measurement the corresponding correction formula is quite similar as described in the cited reference by Schneider (Geophysics, 2008), viz.

$$Δ z = \sqrt{{R ( θ )}^{2} + {R ( θ )}^{2} {( \frac{ϕ}{2} )}^{2}} - R \qquad ( 2 )$$

with the surface azimuth θ with respect to one of the lateral axes and R(θ)=\tilde{R}e^{T} with the vector e=(cos(θ), sin (θ)) and the radius matrix

$$\tilde{R} = [ \begin{matrix}{r}_{xx} & {r}_{xy} \\ {r}_{xy} & {r}_{yy}\end{matrix} ] .$$

For 2D measurements, at a lateral position and specified depth, a one parametric moveout analysis can be performed by varying the residual radius of curvature according to equation (1); otherwise the moveout analysis can be performed as described in the background art for the measured traces. For 3D measurements three parameters have to be determined according to equation (2), for example the two principal radii of the radius matrix and the azimuth of the principal axes with respect to the lateral coordinates (if the dependence on azimuth is neglected, equation (1) may be applied). In both cases it has been assumed so far that the moveout to be corrected is obtained as the reflected response of a continuous formation boundary. In the actual moveout analysis after PSDM according to equations (1), (2) one will usually concentrate on reflected events. However, by using suitable interpolation methods on programmable computers, RDMO corrections can be computed for all values of depth and of lateral position.

Detailed differences to prior art are as follows: A) In the cited reference by Schneider (2007, SEG-meeting) the residual moveout for the CIG at positions 19 was constructed by the downward continuation of the legs of the reflected rays from the shot and receiver position 5, 6 to the migrated reflector 12. For the residual moveout for ADCIGs, a different imaging principle was employed above by considering the upward continuation of the image of the original reflection in the downward continued time section at position 15. In addition, as shown in the cited reference by Schneider (2008, Geophysics) both solutions differ by a lateral shift and the depth moveout in CIGs can not be estimated directly in terms of the residual radius of curvature as in equation (1); instead additional computations have to be performed for the model shown in FIG. 1B in a separate computational step; the computed quantities are used in the moveout analysis. B) It has to be emphasized that the angles 16, 21 considered in the derivation of equations (1), (2) are only available after the construction of ADCIGs according to the approach described in the cited reference by Xu et al., whereas the approach described in the cited reference by Liu et al. was constructed for ACIGs. Another feature in which this invention differs from prior art is that the proposed corrections are strictly valid for laterally inhomogeneous media if the considered offsets and the difference with respect to the true velocity are small. Otherwise, there are no restrictions with respect to lateral variations of velocities or to the curvature of reflecting horizons, except that the application of the acoustic wave equation for PSDM must be valid.

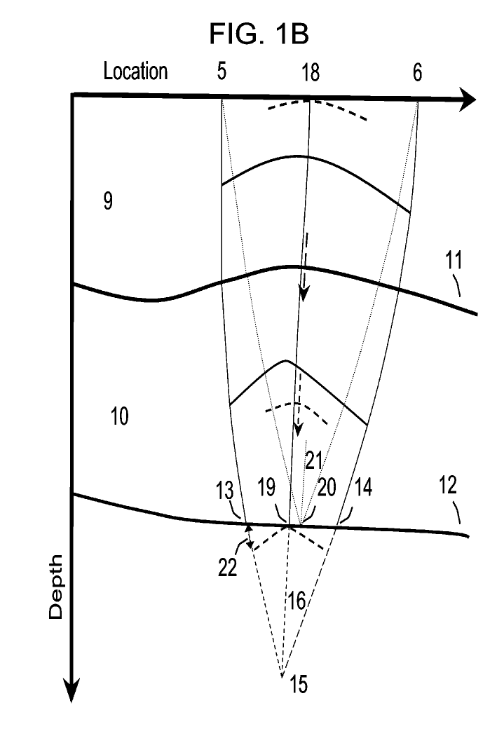

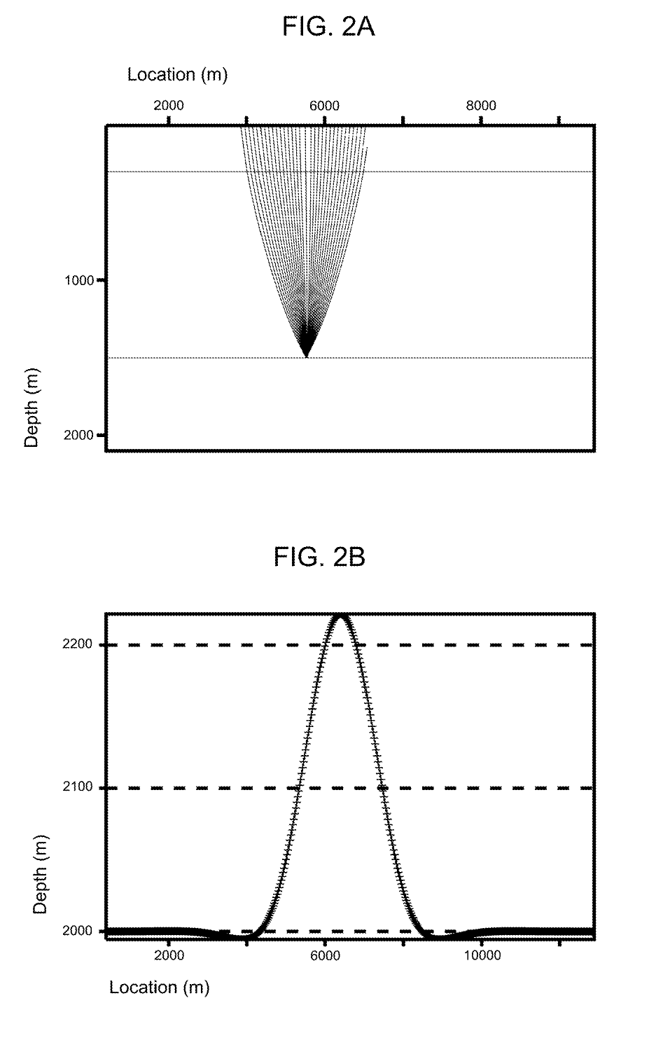

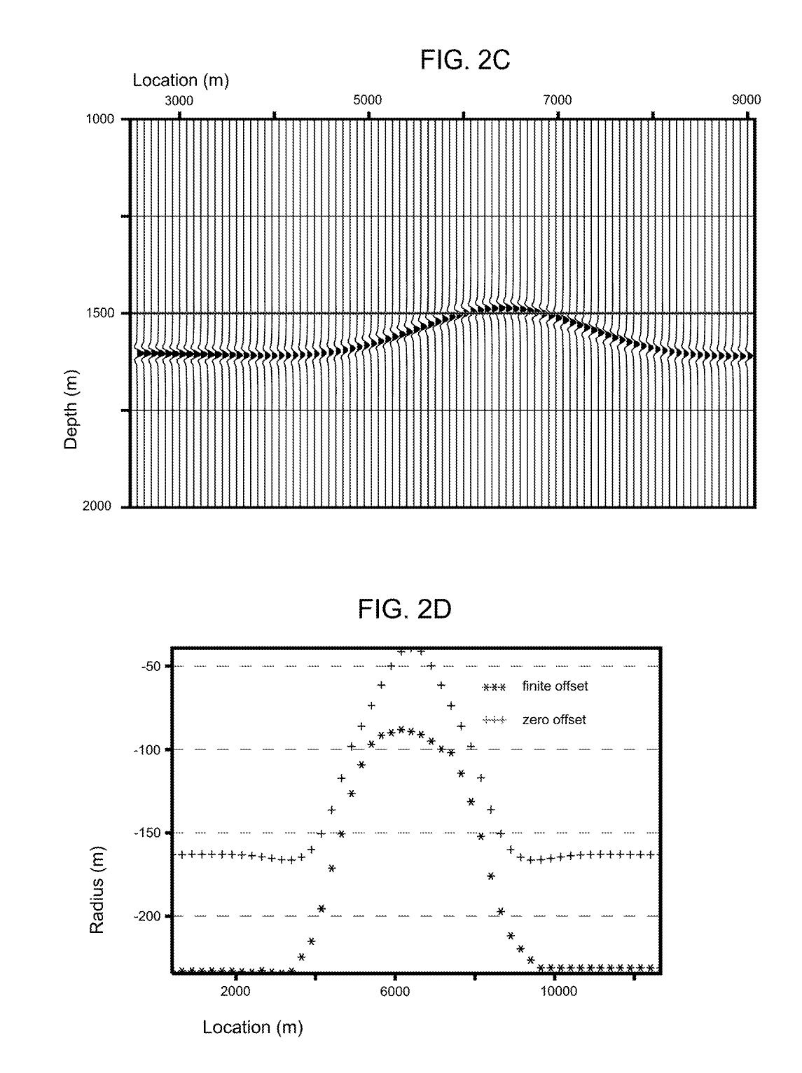

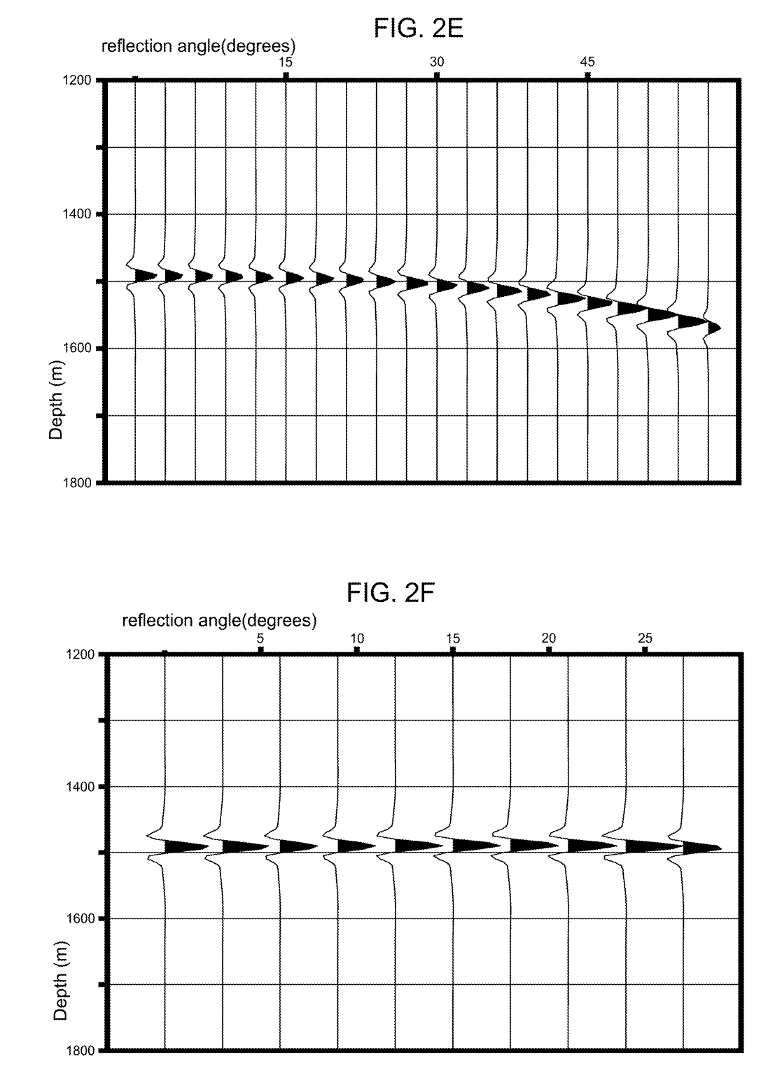

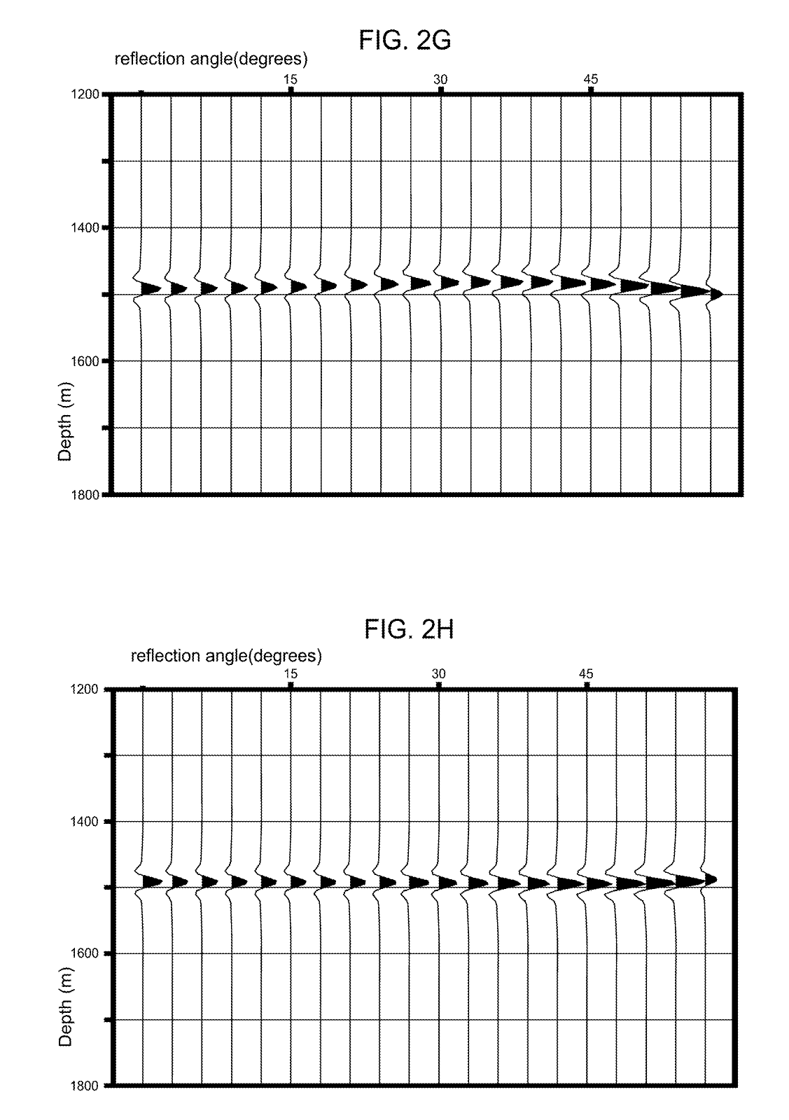

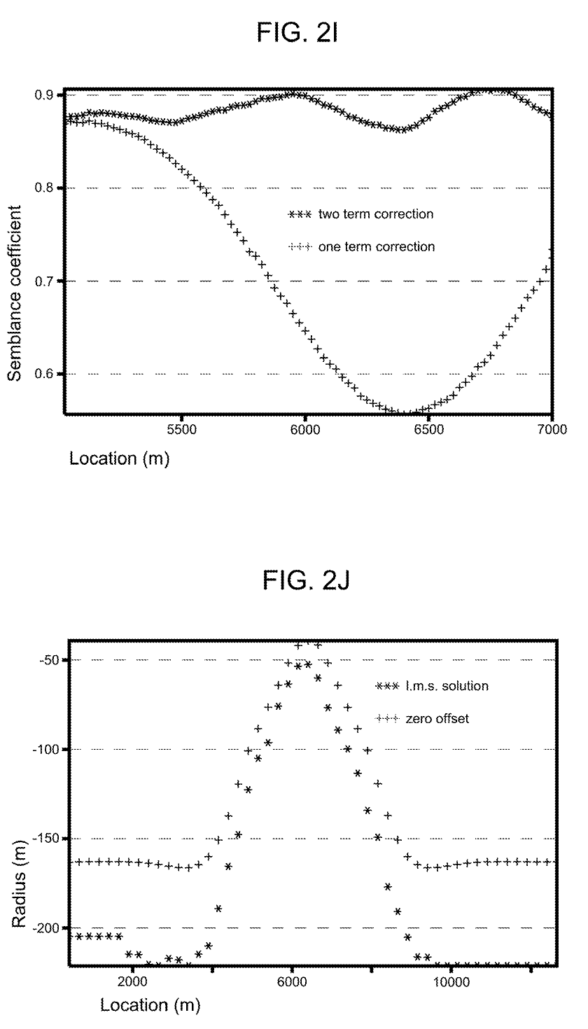

Moveout analysis of seismic data is used in the industry for more than fifty years. It is well known that the characteristic features of this process can be simulated with synthetic data computed with appropriate programs on programmable computers. For this reason the application of the invention will be demonstrated with synthetic data. FIG. 2A shows a depth model consisting of two layers. The formation velocity of the upper layer can be expressed by the relation

$$u ( x , z ) = .7 \frac{1}{s} z + 1700 \frac{m}{s}$$

and for the lower layer by

$$v ( x , z ) = 1.0 \frac{1}{s} z + w ( x )$$

with w(x) shown if FIG. 2B. The synthetic data was calculated for the lower boundary of the second layer according to the continuous profiling method (24 traces per gather, 4800 m maximal offset) by using the asymptotic ray method as described in Cerveny, V., Molotkov, I., and Psencik, I., Ray method in seismology, Charles University Press (1977). This ray method is well known in exploration geophysics and can adequately describe the response for reflected longitudinal waves for this model. The PSDM of the computed data was performed by employing a modified summation method in the common angle domain described in the cited reference by Xu et al. with an erroneous velocity

$$w ( x ) = 2200 \frac{m}{s} .$$

The stacked traces of the PSDM in FIG. 2C show an incorrect position of the reflecting horizon. In addition a distinct moveout is observed for all ADCIGs, in FIG. 2E at the location x=6400 m, under the flank of the velocity distribution w(x) in FIG. 2B. A moveout analysis according to equation (2) was performed for ADCIGs by maximizing semblance coefficients, however, by restricting the common angles considered to 30 degrees (approximately to half of the maximum offset). FIG. 2E shows the residual radii of curvature determined in the analysis as compared to the zero offset values computed along a ray perpendicular to the true reflector position as in FIGS. 1A, 1B. Both graphs are quite similar; an iterative inversion of the determined radii as described in the cited references by Schneider (2008, EAGE, Geophysics) will recover w(x) in FIG. 2B with satisfactory accuracy. The ADCIG in FIG. 2F shows almost horizontal alignment after the application of RDMO for the restricted angular range.

Different results are obtained if all traces in the ADCIGs are considered for the moveout analysis; FIG. 2G shows the same ADCIG after RDMO according to equation (1) with the determined residual radii of curvature. It is apparent that there is residual moveout for the corrected events; in fact, a one term correction according to equation (1) or to an approximation to equation (1) cannot properly correct the events in the ADCIG if all common angles are considered. Series expansions to equations (1), (2) may be used, the coefficients of the expansions have to be determined separately (quite analogously to the expansion of the hyperbolic corrections for large offset time measurements described above); however, it is required that for small reflection angles the expansions is dominated by the zero offset solutions (1), (2), e.g. the coefficients of the expansions in terms of the reflection angle φ are equal up to O[φ⁴] (a function f(φ) is said to be of order O[φ⁴], if there exist constants C and c, such that f(φ)≦C(φ)⁴, whenever φ≦c). These expansions are referred to as expansions of the functional form of equations (1), (2). Examples for 2D measurements and for two term corrections are a Taylor series expansion, viz.

$$Δ z = {{R}_{M} ( \frac{ϕ}{2} )}^{2} + {b ( \frac{ϕ}{2} )}^{4} + O [ {( \frac{ϕ}{2} )}^{6} ]$$

or a rational expansion of the form

$$Δ z = \frac{{{R}_{M} ( \frac{ϕ}{2} )}^{2}}{{( 1 + {a ( \frac{ϕ}{2} )}^{2} )}^{2}} \qquad ( 3 )$$

The coefficients R_{M} and a, b are determined in separate analyses. From the determined coefficients of equation (3) an estimate of R₀, the residual radius of curvature at zero angle may be derived by using suitable optimization techniques. This value may be used to assess the quality of the velocity model used for PSDM or for inversion purposes, e.g. as described in the background art. FIG. 2H shows almost horizontal alignment after a correction with the determined coefficients according to equation (3). This observation is confirmed by the semblance coefficients in FIG. 2I which are small for the one term correction but relatively close to the ideal value of unity for the two term correction according to equation (3). The values of R₀, derived by applying a least mean square (l.m.s.) optimization in FIG. 2J show smaller differences with respect to the zero offset values than the results of FIG. 2D. An iterative inversion of these values is possible.

The illustrative example discussed in FIGS. 2A-J demonstrates the application of the invention for the case of analyzing the response of a reflection boundary after PSDM for the layer stripping approach. It is again emphasized that for both 2D and 3D measurements the invention can be applied to render a complete set of correction parameters as a function of depth and lateral position which can be used for purposes of improving the S/N ratio, to assess the quality of the velocity model and for velocity inversion. It should be noted, however, that in contrast to the cited reference by Liu et al., if inversion is attempted for a laterally inhomogeneous model, this task cannot be accomplished along a singular normal ray. Instead it was suggested in the cited references by Schneider (2008, EAGE, Geophysics) to use an optimization approach which minimizes the residual radii of curvatures of all relevant normal rays simultaneously with respect to appropriate measures.

What is claimed is:

1. A method for processing seismic data, comprising:
prestack depth migrating the seismic data to generate migrated gathers in the common angle domain using an initial velocity model;
performing a residual moveout analysis with the migrated gathers;
determining approximations to the residual radius of curvature or the elements of the radius matrix at zero offset as a function of location and depth based on the residual moveout analysis;
computing moveout corrections as a function of depth and lateral position from the determined residual radii of curvature or the elements of the radius matrix and applying these corrections to the prestack depth migrated data.

2. The method of claim 1 wherein the residual moveout analysis is performed according to zero offset considerations for common angle gathers. The residual radii of curvature or the elements of the radius matrix can be estimated directly from the common angle gathers.

3. The methods as defined in claim 2 wherein the moveout analysis is performed by an approximation to the moveout derived from zero offset considerations.

4. The methods as defined in claim 1 wherein the moveout analysis is performed by an approximation of the functional form derived from zero offset considerations. The residual radii of curvature at zero offset are determined by suitable numerical approximations.

5. The methods of claims 2-4 comprising using the determined residual radii of curvature or the elements of the radius matrix or the approximations of the functional form to correct the depth migrated gathers.

6. The methods of claims 2-4 comprising using the determined residual radii of curvature or the elements of the radius matrix to assess the quality of the initial velocity model or to improve the velocity model.
